(19) United States
(12) Patent Application Publication
(10) Pub. No.: US 2020/0139451 A1
(43) Pub. Date: May 7, 2020

(54) Milling Chuck Having Detachable Components

(71) Applicant: X'POLE PRECISION TOOLS INC., Taoyuan City (TW)

(72) Inventor: Peter CHEN, Taoyuan City (TW)

(21) Appl. No.: 16/177,762

(22) Filed: Nov. 1, 2018

(51) Int. Cl. B23B 31/20

(52) U.S. Cl. CPC B23B 31/202; B23B 2231/2072

(57) ABSTRACT

A chuck includes a hollow mounting part including a conic connection member and a lower support member; a hollow collet including a clamping member partially disposed in the support member and having an axial channel, longitudinal gaps on a surface, each gap having an open bottom, and latches each between two adjacent gaps in which a drill bit is partially inserted into the channel; and a fastener put on both the mounting part and the collet to secure to the support member with the clamping member partially disposed in the fastener, the latches fastened in the fastener, and the drill bit fastened in both the fastener and the channel.

### BACKGROUND OF THE INVENTION

### 1. Field of the Invention

The invention relates to chucks and more particularly to a chuck for a mil and having detachable components.

### 2. Description of Related Art

A conventional chuck comprises a collet mounted to a quill of a mill. The collet is supposed to be capable of fastening a drill bit. In a milling operation, however, it is often that the drill bit may be loosened and in turn, it compromises the desired function of the drill bit. This is because there are no latches provided by the collet.

Further, the conventional collet is not constructed of flexible materials. Thus, additional fastening devices are required to securely fix the drill bit in place. In a milling operation, however, it is often that the drill bit may be loosened due to interference of the additional fastening devices with the chuck. As a result, it still compromises the desired function of the drill bit.

Furthermore, the mounting part and the collet of the conventional chuck are formed integrally and it undesirably limits its flexibility. In a milling operation, however, it is often that the drill bit may be loosened and in turn, it compromises the desired function of the drill bit.

Thus, the need for improvement still exists.

### SUMMARY OF THE INVENTION

It is therefore one object of the invention to provide a chuck for a mill, comprising a separate collet having latches so that a mounted drill bit can be securely fixed in place by the latches.

It is another object of the invention to provide a chuck for a mill comprising a separate collet having latches so that a mounted drill bit can be fastened by the latches.

For achieving above an other objects of the invention, there is provided a chuck for a mill, comprising a hollow mounting part including a conic connection member configured to secure to a quill, and a lower support member integrally formed with the connection member; a hollow collet including a cylindrical clamping member partially disposed in the support member, the clamping member having an axial channel, a plurality of longitudinal gaps on a surface, each gap having an open bottom, and a plurality of latches each formed between two adjacent gaps wherein a drill bit is configured to partially insert into the channel; and a hollow fastener configured to put on both the mounting part and the collet to secure to the support member with the clamping member being partially disposed in the fastener, the latches being flexibly fastened in the fastener, and the drill bit being fastened in both the fastener and the channel.

Preferably, the hollow fastener is a nut including an upper internally threaded section, and wherein the support member includes a lower externally threaded section configured to secure to the internally threaded section.

Preferably, the collet further comprises an upper extension configured to fasten in the support member.

The invention has the following advantages: the chuck has detachable components such as the mounting part and the collet. The latches can be flexibly compressed due to the provision of the gaps. And in turn, the drill bit can be securely fixed by the mounting part, the collet and the fastener. Further, precision and yield of the workpiece being machined by the drill bit can be greatly increased.

### BRIEF DESCRIPTION OF THE DRAWINGS

The invention, as well as its many advantages, may be further understood by the following detailed description and drawings in which:

FIG. 1 is a longitudinal view of a chuck according to the invention mounted on a mill;

FIG. 2 is an exploded view of FIG. 1; and

FIG. 3 is a view similar to FIG. 1 showing a drill bit fastened by the chuck.

### DETAILED DESCRIPTION OF THE INVENTION

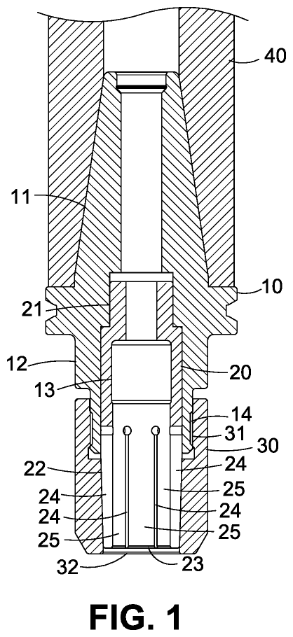

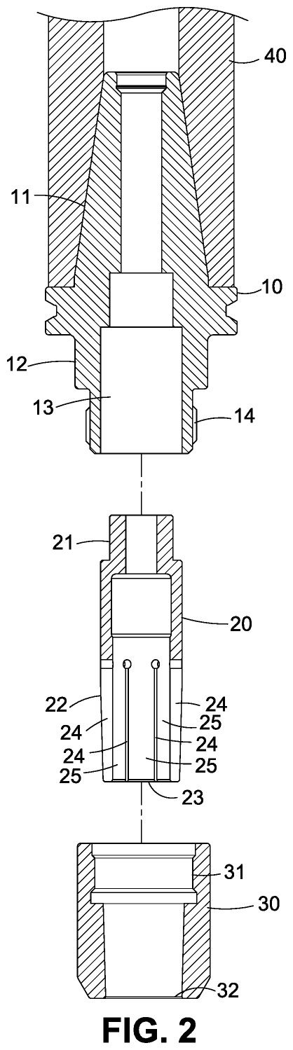

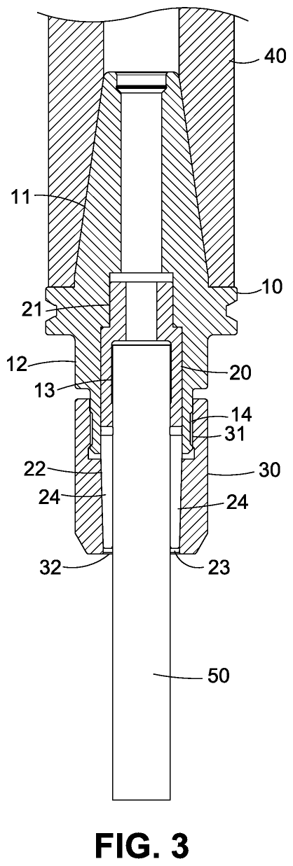

Referring to FIGS. 1 to 3, a chuck in accordance with the invention comprises a mounting part 10 secured to a quill 40 of a mill, a collet 20 and a fastener 30 as discussed in detail below.

The hollow mounting part 10 includes a conic connection member 11 and a lower support member 12 integrally formed with the connection member 11 and having an internal space 13 and an upper externally threaded section 14.

The hollow collet 20 includes an upper extension 21 configured to fasten in a portion of the space 13, and a cylindrical clamping member 22 partially disposed in the space 13 and having an axial channel 23, a plurality of longitudinal gaps 24 on a surface, each gap 24 having a bottom opening, and a plurality of latches 25 each formed between two adjacent gaps 24.

The hollow fastener 30 is implemented as a nut and includes an upper internally threaded section 31 and an axial tunnel 32.

In an operation position, the connection member 11 is secured to the quill 40, and a drill bit 50 is inserted through the tunnel 32 into the channel 23 until being stopped. Further, the fastener 30 is turned to put on both the mounting part 10 and the collet 20 to secure the externally threaded section 14 to the internally threaded section 31, and dispose the clamping member 22 in the fastener 30 with the latches 25 being flexibly fastened in the tunnel 32 due to the provision of the gaps 24. As a result, the drill bit 50 is fastened.

It is envisaged by the invention that the chuck has detachable components such as the mounting part 10 and the collet 20. The latches 25 can be flexibly compressed due to the provision of the gaps 24. And in turn, the drill bit 50 can be securely fixed by the mounting part 10, the collet 20 and the fastener 30. Further, precision and yield of the workpiece being machined by the drill bit 50 can be greatly increased.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A milling chuck, comprising:
a hollow mounting part including a conic connection member configured to secure to a quill, and a lower support member integrally formed with the connection member;
a hollow collet including a cylindrical clamping member partially disposed in the support member, the clamping member having an axial channel, a plurality of longitudinal gaps on a surface, each gap having an open bottom, and a plurality of latches each formed between two adjacent gaps wherein a drill bit is configured to partially insert into the channel; and
a hollow fastener configured to put on both the mounting part and the collet to secure to the support member with the clamping member being partially disposed in the fastener, the latches being flexibly fastened in the fastener, and the drill bit being fastened in both the fastener and the channel.

2. The milling chuck of claim 1, wherein the hollow fastener is a nut including an upper internally threaded section, and wherein the support member includes a lower externally threaded section configured to secure to the internally threaded section.

3. The milling chuck of claim 1, wherein the collet further comprises an upper extension configured to fasten in the support member.
